(19) United States
(12) Patent Application Publication
(10) Pub. No.: US 2006/0036690 A1
(43) Pub. Date: Feb. 16, 2006

(54) Network protection system

(76) Inventor: Patrick J. O'Neil, Dana Point, CA (US)

Correspondence Address: Patrick Lilley, 17 Parma, Irvine, CA, 92602, US

(21) Appl. No.: 10/888,231

(22) Filed: Jul. 12, 2004

(51) Int. Cl. G06F 15/16

(52) U.S. Cl. 709/206

(57) ABSTRACT

The invention includes an anti-spam Protection Device installed on the same network as email servers that it protects, or on a separate network that is connected to the networks of protected email servers. Inbound email connections route to the Protection Device, which evaluates each sending server by employing information from server attribute databases and other sources. The method uses a hierarchical score tree, which is comprised of nodes in a dependent, hierarchical structure. Each node features a score condition triggered by server attribute information, and a score that contributes to the blocking score. A connection evaluated to a blocking score above a threshold is terminated; otherwise the sending server is allowed to deliver the email message through the Protection Device. The Protection Device optionally allows the use of white lists or black lists to allow or deny certain sending email servers.

### FIELD OF THE INVENTION

The present invention relates to a network protection system that prevents unwanted messages from reaching an email network.

### BACKGROUND OF THE INVENTION

Unsolicited commercial email messages, known commonly as “spam”, comprise an increasing volume of email traffic worldwide. Reliable sources estimate that over 80% of email messages are spam. Other sources calculate the business productivity loss from spam to be equivalent to one additional employee at a company of 72 people.

Estimates of more direct monetary cost range from $100 per employee per year to upwards of $500 per employee per year.

One estimate places the cost of spam at over $200 billion per year worldwide. The number of spam messages is also increasing every month faster than the rate of increase in legitimate email messages. Spam is diminishing the value of email as a communications tool, driving businesses to more costly and less efficient alternatives.

The existing state of the art in spam relies on various ways to filter email messages, based either on the content of the messages or on the outcome of an interaction with the sending email server or the original sending user. Most of the existing solutions, such as that described in U.S. Pat. No. 6,161,130, accept spam messages, examine them for content patterns and certain attributes, and classify messages as legitimate or spam. Spam messages can then be quarantined on a server or passed through to the client for local quarantine in a “junk mail” or spam folder.

Some solutions, such as that described as U.S. Pat. No. 6,453,327, rely on “peer to peer” networks of users, or groups of trusted users to identify spam messages and update a communal database of spam message attributes. These are in turn used to filter email messages. Some solutions include very sophisticated methods of filtering, evaluating large numbers of message attributes and thoroughly analyzing message content. These methods may have tens of thousands of processing rules that are updated automatically as messages are received; some even use classification responses from users in order to “learn” and improve the existing rules base. Bayesian probability networks are also used in some solutions; these use complex probability calculations based again on email message attributes and content fragments.

Additional methods to identify spam can include schemes such as “challenge-response” schemes as exemplified in U.S. Pat. Nos. 6,393,465 and 6,112,227, which send a request or an email message back to the sender to test if the sending server and email address is valid. The solutions classify messages as legitimate or spam, and either accept or reject them on the basis of the responses.

Regardless of the actual method used to filter email messages, existing solutions are implemented in one of four forms: client-based software, server-based software, network appliances, and third-party services. Client-based software resides on the computer used by the end user (e-mail recipient), and often integrates with email clients such as Outlook or Eudora. Server-based software resides on the receiving email server or on a separate server whose purpose is to protect the receiving email server. Network appliances, such as Trend Micro's, are devices installed on a network, which are designed to intercept messages intended for the receiving email server, and divert or allow these messages based on some logic. Third-party services, such as those offered by Postini, accept email traffic on behalf of a receiving email server, and use software-based or network appliance-based methods to decide which email messages should be forwarded to the receiving email server, and which messages should be quarantined or deleted.

Some methods also make use of “white lists” of allowed email senders, and “black lists” of always denied email senders. Most white lists and black lists are manually generated. Some solutions allow automated white list generation, by assuming that all outgoing emails are addressed to recipients that would be acceptable senders. This can be problematic if spam messages are allowed through while a user has a “vacation auto-responder” active on the email client. The senders of such spam will automatically be added to a white list.

In summary, combination existing methods can be effective, but they impose unnecessary cost and complexity and do not fulfill the true objective: Removing the burden of spam from a network mail system.

A major weakness of existing solutions is that, in order to classify messages as spam or legitimate, they must accept those messages and responsibility for those messages. Therefore they allow spam messages to be transmitted over the Internet, and must be stored and processed by the anti-spam solution. In the case of network appliances, server-based solutions, and third-party services, this simply moves the cost and scalability burden to the anti-spam solution. In the case of client-based solutions, the network burden remains. For clarity, its necessary to describe the shortcomings of each of the four types of existing solutions.

Client-based software routes spam messages into a junk mail folder in the email client software (such as Outlook or Eudora). In this case the anti-spam solution processes all messages, including spam. The email server handles traffic, storage, and download for all messages including spam. The client PC and software downloads and processes all messages including spam—an inefficient and time-wasting solution when a user is travling and at a hotel where a dial-up connection operates at 20 kbps throughput. No matter what the connection speed, this approach puts an unnecessary burden on all components of the system, as well as the Internet itself. Further, “false positives” legitimate email messages that are erroneously marked as spam) can sit in a folder for days before being noticed among hundreds of bulk emails. Often quarantine systems hold messages for a limited time, then delete messages beyond the limit. In a business context this “black hole” situation is dangerous. Urgent requests from customers can go unacknowledged for days, and relationships can be damaged due to apparent unresponsiveness. Prices for client-based software can range from $50 per user license to perhaps 10% of that in volume. However, any client-side software imposes a huge management burden on IT personnel. The cost of installing, troubleshooting, and updating software on many PC's with different configurations, let alone training users, far outweighs the price of the software itself.

In the case of a typical network appliance that filters spam, again the appliance, the mail server, and the client PC each process all legitimate and spam messages. This puts an unnecessary load on the whole network email system. Some network appliances quarantine spam messages on a server, and thereby reduce the load on the client PC, and sometimes the email server too. However, this requires an additional server or a more expensive anti-spam appliance due to storage requirements. Also, server-side quarantines suffer from the same “black hole” problem as client-side quarantine folders, where important messages go unread for days or longer. Although the algorithms in such appliances can be very clever, using advanced statistical classification techniques, pattern recognition, and automated rule generation, they can therefore be very complex and computation-intensive. Collateral from Brightmail indicates that one of their solutions can automatically generate up to 30,000 new mail-handling rules per day. This sounds impressive, but it's inefficient and requires very powerful processing capability and extra storage. This is why network appliances can range from $10,000 to $30,000 for purchase and installation, plus annual support fees, and sometimes even annual per-user fees. Such complexity also mandates lengthy, well-planned installation procedures and high total cost of ownership.

Server-based solutions that filter spam have characteristics and disadvantages very similar to those of network appliances. In addition to the shortcomings of existing network appliances, server-based solutions also add security risks, because they typically run on full-bore server operating systems that require frequent patches to keep ahead of security loopholes discovered by hackers. Further, some of these solutions run on the email server itself, adding additional CPU and storage load and increasing the chance of unexpected interactions between software services running on the same machine.

Third party service solutions would seem to clear away a lot of these objections. In reality they just move the burden around. Some corporate IT staff could be glad to have specialists managing the anti-spam solution, instead of adding burden to their own network and workdays. But all those spam messages still are transmitted over the Internet, examined, and placed in quarantine on a server somewhere. The service provider may be able to manage this more efficiently than an IT staff, due to scale and focused expertise. However, the service provider must still build in a profit, and will typically charge in the range of $3 per employee and up every month, plus start-up charges. This can become expensive over time, and the payments are perpetual as long as the service is used. There are two other problems with such services. First, such services quarantine spam on a server, for periodic review by the user. The dangers of routing falsely marked legitimate messages to “needle in a haystack” or “black hole” quarantines are clear. Second, third-party services by definition route all incoming confidential email through that third party. Though the client corporation using such a service may (or may not) be comfortable with such an arrangement, it is reasonable to question whether that corporation's partners, suppliers, and customers are comfortable with it, or even aware of it. There may be liabilities associated with tacitly representing to outside parties that their emails are going directly to the corporation, when in fact the emails are being routed and stored elsewhere.

What's needed is a solution that minimizes cost of purchase, cost of ownership, and cost of false positives, while operating at accuracy levels at or above the best existing solutions of any type.

It is therefore an object of the invention to reduce the burden of spam on an email network, by preventing the transmission and delivery of messages deemed to be spam.

It is another object of the invention to minimize the purchase cost of protecting email servers from spam, by use of an efficient system using a low-cost network protection device.

It is another object of the invention to minimize configuration and maintenance, by using available public and/or private databases of sending email server attributes, rather than requiring extensive “white list” and “black list” maintenance.

It is another object of the invention to minimize the number of actual spam messages that reach the protected email servers, and therefore the protected email recipients.

It is another object of the invention to minimize the number of legitimate email messages that are erroneously determined to be spam.

### SUMMARY OF THE INVENTION

In accordance with the present invention, there is provided a Protection Device. The Protection Device is installed on the same network as email servers that it protects, or on a separate network that is connected to the networks of protected email servers. Inbound email connections route to the Protection Device, which evaluates each sending server by employing information from server attribute databases and other sources. The method uses a hierarchical score tree, which is comprised of nodes in a dependent, hierarchical structure. Each node features a score condition triggered by server attribute information, and a score that contributes to the blocking score. A connection evaluated to a blocking score above a threshold is terminated; otherwise the sending server is allowed to deliver the email message through the Protection Device. The Protection Device optionally allows the use of white lists or black lists to allow or deny certain sending email servers.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a logical view of a/an email network with a Network Protection System installed;

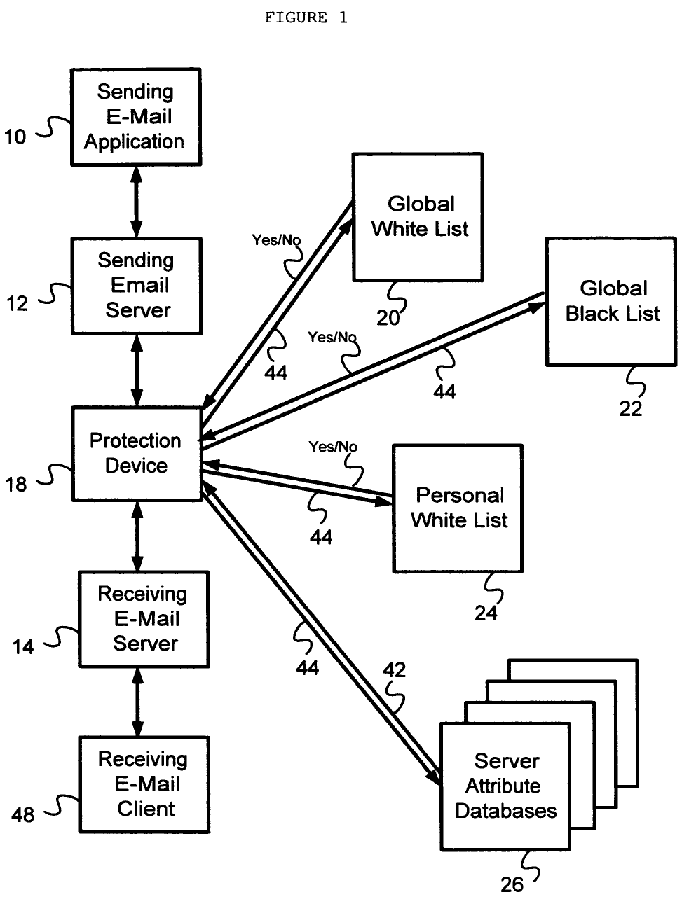

FIG. 2 is a logical view of a flowchart view of the decision process used by the Protection Device; and

FIG. 3 is a logical view of a logical view of a Hierarchical Score Tree.

For purposes of clarity and brevity, like elements and components will bear the same designations and numbering throughout the FIGURES.

### DESCRIPTION OF THE PREFERRED EMBODIMENT

A Network Protection System is Comprised of Several Elements.

The central element of the Network Protection System is a Protection Device 18, which is installed on the local-area network on which is located each Receiving Email Server 14 to be protected. Optionally, a Protection Device 18 is installed outside this local area network, but can connect to each Receiving Email Server 14 using the Internet or other network.

In the case where Protection Device 18 is installed on the local-area network with a Receiving Email Server 14, each Receiving Email Server 14 is configured with a new IP Address 44. The former IP Address 44 of each Receiving Email Server 14 is assigned to Protection Device 18. Optionally, the Protection Device 18 is assigned a valid IP Address 44, and the DNS record for the domain name of each Receiving Email Server 14 is changed to resolve to Protection Device 18, while the Receiving Email Server's IP Address 44 is not changed.

In the case where Protection Device 18 is installed outside the local-area network on which is located a Receiving Email Server 14, the IP Address 44 of each Receiving Email Server 14 is not changed. Protection Device 18 is assigned an IP Address 44 for each protected Receiving Email Server 14, and the DNS record for the domain name of each Receiving Email Server 14 is changed to resolve to Protection Device 18.

After installation in either of these cases, Protection Device 18 accepts email connection attempts from any Sending Email Server 12 on behalf of each Receiving Email Server 14, from which in turn a Receiving Email Client 48 can retrieve messages.

The Protection Device 18 functions by making use of Server Information 42 from public or private Server Attribute Databases 26, and optionally other information, to calculate a Blocking Score 32. The Blocking Score 32 is compared to a Failing Threshold 34 to determine whether to allow or disallow a Sending Email Server 12 to send an email message to a protected Receiving Email Server 14.

The Blocking Score 32 is determined by a novel, efficient, and effective method involving the use of a Hierarchical Score Tree 28, described in more detail below. The use of this method results in highly accurate identification of sources of spam, very low “false positives” (legitimate email servers classified as spam sources), and very efficient use of computing and communication resources. Together these advantages provide a price/performance ratio far superior to existing solutions, and enable packaging of the Protection Device 18 in a low-cost, embedded systems platform or a software application that uses minimal server resources.

The method of allowing or disallowing the Sending Email Server 12 is a novel, efficient, and effective method involving the termination of a mail connection. The termination is done with Rejection Information 46 that includes an error code that prevents the transmission of the email message, optionally adding handling or other information to the error code. The Protection Device 18 may use any standard email connection error code. Each, in combination with optional handling information, indicates to any legitimate sender that a connection was rejected. For example, Rejection Information 46 may include customized text including an email blocking policy, alternate means of contacting the recipient (e.g. phone, fax, mailing, Web page), or other information desired by the Protection Device 18 operator. The optional inclusion of handling information with an error code provides not only a positive feedback mechanism to the rejected sender, but can provide additional instructions to resolve any problems in the case of a Sending Email Server 12 that was incorrectly identified as a source of spam.

The prevention of transmission saves communications costs for the protected email network, as well as for the “public Internet”, across which email messages are normally transmitted. Most importantly, with the method of termination resulting in a legitimate sender knowing about a delivery failure, false positives do not cause the “black hole” problem of existing quarantine solutions, where critical messages may reside for days in a spam folder among many spam messages. Instead a legitimate sender may be expected to contact the intended recipient by phone or other method, in which case the legitimate sender can optionally be added to a Global White List 20 or Personal White List 24.

The Protection Device 18 itself is comprised of several elements, including a hardware computing device on which is installed software or firmware, as well as an optional Global White List 20, optional Global Black List 22, optional Personal White List 24, Blocking Score 32, Failing Threshold 34, optional Delaying Threshold 36, and Hierarchical Score Tree 28.

The optional Global White List 20 is a database, each record of which contains an identifier or identifiers for each Sending Email Server 12 that is explicitly allowed to send email messages to the Receiving Email Server 14. In the preferred embodiment, an optional Global White List 20 is stored within the Protection Device 18. In another embodiment, an optional Global White List 20 is stored outside the Protection Device 18, but is accessible to the Protection Device 18.

The optional Global Black List 22 is a database, each record of which contains an identifier or identifiers for each Sending Email Server 12 that is explicitly prohibited from sending email messages to the Receiving Email Server 14. In the preferred embodiment, an optional Global Black List 22 is stored within the Protection Device 18. In another embodiment, an optional Global Black List 22 is stored outside the Protection Device 18, but is accessible to the Protection Device 18.

The optional Personal White List 24 is a database, each record of which contains an identifier or identifiers for an email user of a protected Receiving Email Server 14, paired with an identifier or identifiers for a Sending Email Server 12 that is explicitly prohibited from sending email messages to that email user. In the preferred embodiment, an optional Personal White List 24 is stored within the Protection Device 18. In another embodiment, an optional Personal White List 24 is stored outside the Protection Device 18, but is accessible to the Protection Device 18.

The Blocking Score 32 is a score that the Protection Device 18 calculates by use of a Hierarchical Score Tree 28 and Server Information 42 from public or private Server Attribute Databases 26, and optionally other information.

The Failing Threshold 34 is a configurable threshold that the Protection Device 18 compares with the Blocking Score 32 to determine if the Blocking Score 32 should result in an accepted or denied email connection.

The optional Delaying Threshold 36 is a configurable threshold that the Protection Device 18 compares with the Blocking Score 32 to determine if the Blocking Score 32 should result in an accepted or temporarily denied email connection.

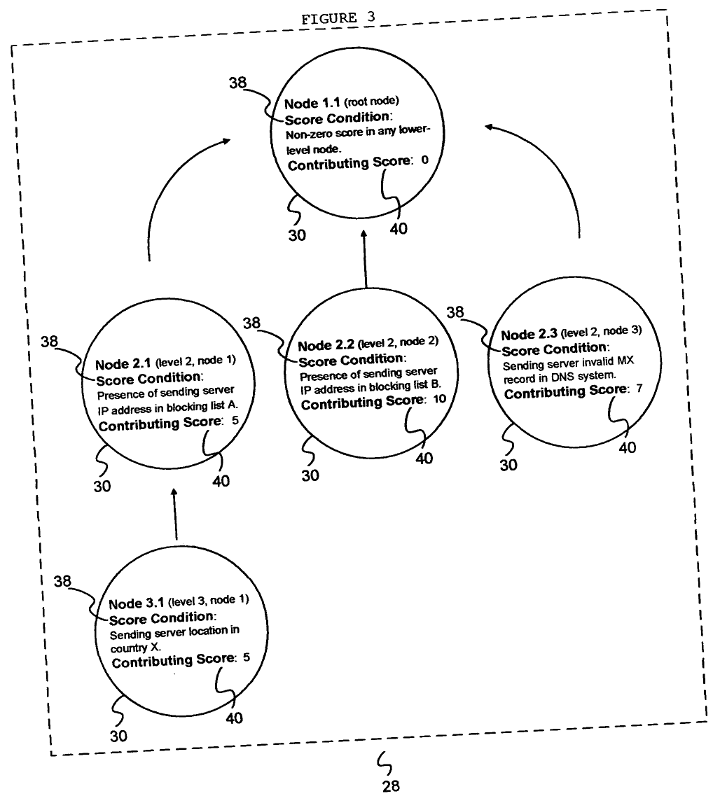

A Hierarchical Score Tree 28, of which an example is depicted in FIG. 3, is comprised of a Node 30, or more than one Node 30 in a dependent, hierarchical structure. Node 30 arrangement consists of one or more levels, each level containing one Node 30 or more than one Node 30. Each Node 30 features a Score Condition 38 triggered by Server Information 42 or other information, and a Contributing Score 40 that contributes to a Blocking Score 32. In the preferred embodiment, a Hierarchical Score Tree 28 is stored on the Protection Device 18. In another embodiment, the Hierarchical Score Tree 28 is stored outside the Protection Device 18, but is accessible to the Protection Device 18.

A Score Condition 38 is a logical statement evaluating to true or false. An example is the presence or absence of an IP Address 44 of a Sending Email Server 12 in a any Server Attribute Databases 26 such as public DNS blocking lists of known sources of spam. Another example is Server Information 42 indicating whether or not a Sending Email Server 12 is located in a particular country. Another example is the presence or absence of an error condition resulting from an MX record query of the Internet DNS system.

A Contributing Score 40 may be positive, negative, or zero. A Contributing Score 40 is the score contributed to the Blocking Score 32 by a Node 30 if the Score Condition 38 of that Node 30 is met, AND the Score Condition 38 is met for the Node 30 on which said Node 30 depends. In the FIG. 3 example, the 3.1 Node 30 will only contribute its Contributing Score 40 of 5 if its Score Condition 38 “Sending server located in country X”) is met, AND if the Score Condition 38 (“Presence of sending server IP Address 44 in blocking list A”) of the 2.1 Node 30 is also met.

A Hierarchical Score Tree 28 may be configured with a variety of topologies from one to many layers, each including one Node 30 or more than one Node 30.

For example, one embodiment of a Hierarchical Score Tree 28 could be comprised of a single Node 30. This enables use of a single Score Condition 38, such as presence of an IP Address 44 of a Sending Email Server 12 on a black list, to calculate a Contributing Score 40, which due to the singular Node 30 would then become the Blocking Score 32.

Another embodiment of a Hierarchical Score Tree 28 could be comprised of a single layer of more than one Node 30 this enables use of more than one Node 30 without any dependency of one Node 30 to another. This is useful for representing a set of conditions, any one of which could contribute to the Blocking Score 32 without depending on the value of any other Node 30 representing another condition.

Also, each Score Condition 38 and Contributing Score 40 may be changed by manual configuration or automated adjustment based on performance history and other information. This enables Protection Device 18 to be optionally adjusted or to self-adjust over time to improve effectiveness, calculation efficiency, or other performance metrics.

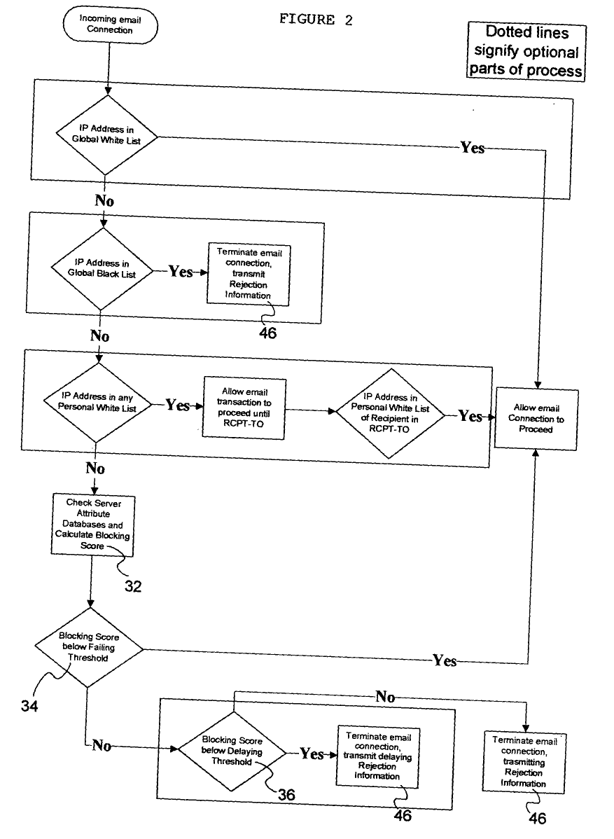

Keeping in mind all of the above elements, a Network Protection System operates as flowcharted in FIG. 2 and explained in sections A through H below:

A. A Sending Email Server 12 attempts an email connection to Protection Device 18, which is acting on behalf of a Receiving Email Server 14. Typically a Sending Email Server 12 will be attempting to deliver an email message delivered to it by a Sending Email Application 10, which can be an email client such as Microsoft Outlook, or a bulk email creation application.

B. The Protection Device 18 receives initial email connection information from the Sending Email Server 12, obtaining the IP Address 44 and optionally other attributes of the Sending Email Server 12.

C. Optionally, Protection Device 18 determines whether the IP Address 44 of the Sending Email Server 12 is in Global White List 20. If this IP Address 44 is in Global White List 20, then Protection Device 18 allows the email transaction to proceed, by passing through email session information to Receiving Email Server 14, optionally inserting any desired or necessary information into the packet stream. After completion of the email session for transmission of the email message, the email connection is terminated normally.

D. Optionally, if no Global White List 20 evaluation was performed, or if IP Address 44 is not in Global White List 20, then Protection Device 18 determines whether IP Address 44 is in Global Black List 22. If IP Address 44 is in Global Black List 22, then Protection Device 18 terminates the email session, transmitting Rejection Information 46 to the Sending Email Server 12.

E. Optionally, if no black list evaluation was performed, or if IP Address 44 is not in Global Black List 22, then Protection Device 18 determines whether IP Address 44 is in a Personal White List 24. If IP Address 44 is in the Personal White List 24, then Protection Device 18 allows the email transaction to proceed until “RCPT-TO:” information is encountered. Protection Device 18 then checks the Personal White List 24 for the recipient identified by the “RCPT-TO:” information. If the recipient is present in the Personal White List 24, and the IP Address 44 is identified as allowed by the same recipient, Protection Device 18 allows the email transaction to proceed by passing through email session information to Receiving Email Server 14, optionally inserting any desired or necessary information into the packet stream. After completion of the email session for transmission of the email message, the email connection is terminated normally.

F. Protection Device 18 queries any Server Attribute Databases 26 required to evaluate Score Conditions of Nodes in a Hierarchical Score Tree 28, or queries one or more temporary caches, to determine whether the IP Address 44 is in any of the Server Attribute Databases 26, or to obtain Server Information 42 by querying based on IP Address 44 or other information obtained from the email connection.

G. Using resulting Server Information 42, Protection Device 18 uses a Hierarchical Score Tree 28 to determine a Blocking Score 32 for IP Address 44, in the context of the current email transaction attempt. Optionally the Blocking Score 32 can influence a stored score that can be used across multiple transaction attempts from a particular IP Address 44.

H1. If the Blocking Score 32 is below a Failing Threshold 34, then Protection Device 18 allows the email transaction to proceed by passing through email session information to Receiving Email Server 14, optionally inserting any desired or necessary information into the packet stream. After completion of the email session for transmission of the email message, the email connection is terminated normally.

H2. If the Blocking Score 32 is at or above a Failing Threshold 34, then Protection Device 18 executes the appropriate blocking action. For example, in one embodiment, Protection Device 18 terminates the email session, transmitting Rejection Information 46 to the Sending Email Server 12.

H3. In another embodiment, an additional Delaying Threshold 36 is used. If the Blocking Score 32 is above the Delaying Threshold 36, but below the Failing Threshold 34, Protection Device 18 terminates the email session, transmitting Rejection Information 46 indicating temporary unavailability of Receiving Email Server 14. This enables the Sending Email Server 12 to re-try the transaction at a later time, when Server Attribute Databases 26 may have changed.

H4. In another embodiment, a series of thresholds may be used to choose from a variety of actions of varying severity, from various kinds of temporary delays or queuing, to termination of an email session with more severe Rejection Information 46, for example an SMTP Code 554.

The above describes the overall process by which a Network Protection System operates to prevent spam from burdening an email network, within the context of an email network.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A network protection system for preventing unwanted messages from reaching an email network comprising:
means for receiving email allowed by the protection system;
means for protecting an email network from the burden of spam, virtually connected to said means for receiving email allowed by the protection system;
means for obtaining information about a sending email server, intermittently connected to said means for protecting an email network from the burden of spam;
means for storing logic and parameters used to determine a blocking score;
means for representing in a hierarchical score tree decision logic, score condition and contributing score, logically joined to said means for storing logic and parameters used to determine a blocking score;
means for storing the result of a hierarchical score tree calculation;
means for determining whether a blocking score should result in an accepted or denied email connection;
means for storing in a node the condition under which a contributing score of the node would be used in calculating a blocking score, logically joined to said means for representing in a hierarchical score tree decision logic, score condition and contributing score;
means for storing in a node the score that the node contributes to the blocking score if the score condition of the node is met, logically joined to said means for representing in a hierarchical score tree decision logic, score condition and contributing score;
means for triggering node conditions within nodes;
means for identifying a sending email server; and
means for indicating to a sending email server that an email connection was rejected.

2. The network protection system in accordance with claim 1, wherein said means for receiving email allowed by the protection system comprises a receiving email server.

3. The network protection system in accordance with claim 1, wherein said means for protecting an email network from the burden of spam comprises a protection device.

4. The network protection system in accordance with claim 1, wherein said means for obtaining information about a sending email server comprises a public or private server attribute databases.

5. The network protection system in accordance with claim 1, wherein said means for storing logic and parameters used to determine a blocking score comprises a hierarchical score tree.

6. The network protection system in accordance with claim 1, wherein said means for representing in a hierarchical score tree decision logic, score condition and contributing score comprises a node.

7. The network protection system in accordance with claim 1, wherein said means for storing the result of a hierarchical score tree calculation comprises a blocking score.

8. The network protection system in accordance with claim 1, wherein said means for determining whether a blocking score should result in an accepted or denied email connection comprises a failing threshold.

9. The network protection system in accordance with claim 1, wherein said means for storing in a node the condition under which a contributing score of the node would be used in calculating a blocking score comprises a score condition.

10. The network protection system in accordance with claim 1, wherein said means for storing in a node the score that the node contributes to the blocking score if the score condition of the node is met comprises a contributing score.

11. The network protection system in accordance with claim 1, wherein said means for triggering node conditions within nodes comprises a server information.

12. The network protection system in accordance with claim 1, wherein said means for identifying a sending email server comprises an ip address.

13. The network protection system in accordance with claim 1, wherein said means for indicating to a sending email server that an email connection was rejected comprises a rejection information.

14. A network protection system for preventing unwanted messages from reaching an email network comprising:
a receiving email server, for receiving email allowed by the protection system;
a protection device, for protecting an email network from the burden of spam, virtually connected to said Receiving Email Server;
a public or private server attribute databases, for obtaining information about a sending email server, intermittently connected to said Protection Device;
a hierarchical score tree, for storing logic and parameters used to determine a blocking score;
a node, for representing in a hierarchical score tree decision logic, score condition and contributing score, logically joined to said Hierarchical Score Tree;
a blocking score, for storing the result of a hierarchical score tree calculation;
a failing threshold, for determining whether a blocking score should result in an accepted or denied email connection;
a score condition, for storing in a node the condition under which a contributing score of the node would be used in calculating a blocking score, logically joined to said Node;
a contributing score, for storing in a node the score that the node contributes to the blocking score if the score condition of the node is met, logically joined to said Node;
a server information, for triggering node conditions within nodes;
an ip address, for identifying a sending email server; and
a rejection information, for indicating to a sending email server that an email connection was rejected.

15. A network protection system for preventing unwanted messages from reaching an email network comprising:
a receiving email server, for receiving email allowed by the protection system;
a protection device, for protecting an email network from the burden of spam, virtually connected to said Receiving Email Server;
a public or private server attribute databases, for obtaining information about a sending email server, intermittently connected to said Protection Device;
a hierarchical score tree, for storing logic and parameters used to determine a blocking score;
a node, for representing in a hierarchical score tree decision logic, score condition and contributing score, logically joined to said Hierarchical Score Tree;
a blocking score, for storing the result of a hierarchical score tree calculation;
a failing threshold, for determining whether a blocking score should result in an accepted or denied email connection;
a score condition, for storing in a node the condition under which a contributing score of the node would be used in calculating a blocking score, logically joined to said Node;
a contributing score, for storing in a node the score that the node contributes to the blocking score if the score condition of the node is met, logically joined to said Node;
a server information, for triggering node conditions within nodes;
an ip address, for identifying a sending email server; and
a rejection information, for indicating to a sending email server that an email connection was rejected.
